(19) United States
(12) Patent Application Publication
(10) Pub. No.: US 2025/0135410 A1
(43) Pub. Date: May 1, 2025

(54) Multiple Submergence Depth Diffused Air System and Methods of Diffusing Air

(71) Applicant: Red Valve Company, Inc., Pittsburgh, PA (US)

(72) Inventor: Jeffrey T. Kelly, Pittsburgh, PA (US)

(21) Appl. No.: 18/933,630

(22) Filed: Oct. 31, 2024

Related U.S. Application Data
(60) Provisional application No. 63/595,137, filed on Nov. 1, 2023.

(51) Int. Cl. B01F 23/231; B01F 23/23; B01F 23/237; B01F 23/50; B01F 33/40; B01F 35/50; B01F 35/71

(52) U.S. Cl. CPC B01F 23/23121; B01F 23/23113; B01F 23/231265; B01F 23/2366; B01F 23/237611; B01F 23/51; B01F 23/59; B01F 33/401; B01F 33/4062; B01F 33/409; B01F 35/50; B01F 35/7176

(57) ABSTRACT

A multiple submergence depth diffused air system includes: a vessel having a non-flat bottom floor and fluid; a single blower or compressor that provides a single mass flow and a single pressure discharge of air; a plurality of air distribution lines that extend from the single blower or compressor into the fluid, in which outlets of the plurality of air distribution lines have grids with air diffuser units for distributing air; and orifice plates associated with each air distribution line. At least some of the air distribution lines extend to different depths within the fluid and at least one of the air distribution lines extend into the fluid formed in the non-flat bottom floor of the vessel. The orifice plates can also be sized and configured to produce a unique pressure head for each air distribution line at a designated mass flow of air to the respective air distribution line.

### CROSS-REFERENCE TO RELATED APPLICATIONS

This application claims the benefit of U.S. Provisional Patent Application No. 63/595,137 filed Nov. 1, 2023, the disclosure of which is incorporated herein by reference in its entirety.

### BACKGROUND OF THE INVENTION

### Field of the Invention

This invention generally relates to a diffused air system, and more particularly to a multiple submergence depth diffused air system and methods of using the same.

### Description of Related Art

Diffused air is applied to fluid bodies to provide mixing of the fluid, solids suspension, and/or dissolved oxygen transfer. Historically, diffused air systems consist of a single blower which produces an individual set mass airflow at a specific discharge pressure and involves discharging air into a multi-port diffusion system consisting of a distribution grid of piping containing individual diffuser units. Since the blower units can only provide a single pressure point, the air diffuser distribution piping grid must be located at one hydrostatic pressure elevation. Any variance in the hydrostatic pressure across the distribution system will result in an undesirable flowrate to the high and low elevation locations of the system.

These historical configurations are limited to installing the distribution grid and diffuser discharges at the same elevation, regardless of the vessel floor and vessel bottom configuration. These systems are also limited to applications with containment vessels that contain flat floors and are not recommended for sloped floors or conical bottom vessels. If the fluid body storage vessel has a non-flat floor (sloped or conical shaped) then traditional diffused air systems are limited in these configurations to installing the diffuser grid at one consistent elevation across the entire piping grid, which is typically located above the conical area due to limited area for the diffusion equipment.

Thus, it is desirable to provide an improved diffused air system that does not have the drawbacks with other known systems.

### SUMMARY OF THE INVENTION

In certain non-limiting embodiments, the present disclosure includes a multiple submergence depth diffused air system. The system includes: a vessel comprising a non-flat bottom floor and fluid contained within the vessel; a single blower or compressor that provides a single mass flow and a single pressure discharge of air; a plurality of air distribution lines that extend from the single blower or compressor into the fluid contained within the vessel, in which outlets of the plurality of air distribution lines have grids comprising air diffuser units for distributing air into the fluid; and orifice plates associated with each air distribution line. At least some of the air distribution lines extend to different depths within the fluid of the vessel and at least one of the air distribution lines extends into the fluid formed in the non-flat bottom floor of the vessel. The orifice plates can also be sized and configured to produce a unique pressure head for each air distribution line at a designated mass flow of air to the respective air distribution line.

In certain non-limiting embodiments, the non-flat bottom floor is sloped. For example, the non-flat bottom floor can be sloped to form a conical shaped floor.

In some non-limiting embodiments, the plurality of air distribution lines extend to different depths within the fluid of the vessel. Further, at least two of the plurality of air distribution lines can extend into the fluid formed in the non-flat bottom floor of the vessel at different depths.

In certain non-limiting embodiments, the air diffuser units are positioned at different elevations within the fluid of the vessel and at least one of the air diffuser units is positioned within the fluid formed in the non-flat bottom floor of the vessel.

In certain non-limiting embodiments, the sizes of the orifice plates, mass flow of air for distribution to the grids, and operating pressure of air to the grids are calculated based on a mathematical model. The orifice plates can be positioned above a surface of the fluid contained in the vessel.

In some non-limiting embodiments, the system further includes an air distribution header pipe comprising a first end connected with the blow or compressor, and the air distribution lines are connected to a second end of the air distribution header pipe.

In certain non-limiting embodiments, the present disclosure further includes method of diffusing air into a vessel for mixing fluids, solids suspension, and/or dissolved oxygen transfer. The method includes: distributing air from a single blower or compressor into a plurality of air distribution lines that extend into a vessel comprising a non-flat bottom floor and fluid contained within the vessel, the blower or compressor providing a single mass flow and a single pressure discharge of air; producing a unique pressure head for each air distribution line at a designated mass flow of air to each respective air distribution line by individual orifice plates associated with each air distribution line; distributing air through each air distribution line at a proportional airflow associated with a fluid volume designated for each air distribution line; discharging air at the designated mass flow of air and an operating pressure to outlets of the plurality of air distribution lines comprising grids with air diffuser units; and releasing air from the air diffuser units to mix the fluid, provide solids suspension, and/or dissolve oxygen. At least some of the air distribution lines extend to different depths within the fluid of the vessel and at least one of the air distribution lines extends into the fluid formed in the non-flat bottom floor of the vessel.

In some non-limiting embodiments, the method further includes distributing air from the blower or compressor to an air distribution header pipe that is connected to the air distribution lines. The method can also include any of the previously described components and configurations of the system.

The present disclosure is also directed to the following aspects.

Aspect 1: A multiple submergence depth diffused air system comprising: a vessel comprising a non-flat bottom floor and fluid contained within the vessel; a single blower or compressor that provides a single mass flow and a single pressure discharge of air; a plurality of air distribution lines that extend from the single blower or compressor into the fluid contained within the vessel, in which outlets of the plurality of air distribution lines have grids comprising air diffuser units for distributing air into the fluid; and orifice plates associated with each air distribution line, wherein at least some of the air distribution lines extend to different depths within the fluid of the vessel and at least one of the air distribution lines extend into the fluid formed in the non-flat bottom floor of the vessel, and wherein the orifice plates are sized and configured to produce a unique pressure head for each air distribution line at a designated mass flow of air to the respective air distribution line.

Aspect 2: The system according to aspect 1, wherein the non-flat bottom floor is sloped.

Aspect 3: The system according to aspect 2, wherein the non-flat bottom floor is sloped to form a conical shaped floor.

Aspect 4: The system according to any of the preceding aspects, wherein all of the plurality of air distribution lines extend to different depths within the fluid of the vessel.

Aspect 5: The system according to any of the preceding aspects, wherein at least two of the plurality of air distribution lines extend into the fluid formed in the non-flat bottom floor of the vessel at different depths.

Aspect 6: The system according to any of the preceding aspects, wherein the air diffuser units are positioned at different elevations within the fluid of the vessel and at least one of the air diffuser units is positioned within the fluid formed in the non-flat bottom floor of the vessel.

Aspect 7: The system according to any of the preceding aspects, wherein sizes of the orifice plates, mass flow of air for distribution to the grids, and operating pressure of air to the grids are calculated based on a mathematical model.

Aspect 8: The system according to any of the preceding aspects, wherein the orifice plates are positioned above a surface of the fluid contained in the vessel.

Aspect 9: The system according to any of the preceding aspects, further comprising an air distribution header pipe comprising a first end connected with the blow or compressor, and the air distribution lines are connected to a second end of the air distribution header pipe.

Aspect 10: A method of diffusing air into a vessel for mixing fluids, solids suspension, and/or dissolved oxygen transfer, the method comprising: distributing air from a single blower or compressor into a plurality of air distribution lines that extend into a vessel comprising a non-flat bottom floor and fluid contained within the vessel, the blower or compressor providing a single mass flow and a single pressure discharge of air; producing a unique pressure head for each air distribution line at a designated mass flow of air to each respective air distribution line by individual orifice plates associated with each air distribution line; distributing air through each air distribution line at a proportional airflow associated with a fluid volume designated for each air distribution line; discharging air at the designated mass flow of air and an operating pressure to outlets of the plurality of air distribution lines comprising grids with air diffuser units; and releasing air from the air diffuser units to mix the fluid, provide solids suspension, and/or dissolve oxygen, wherein the at least some of the air distribution lines extend to different depths within the fluid of the vessel and at least one of the air distribution lines extends into the fluid formed in the non-flat bottom floor of the vessel.

Aspect 11: The system according to aspect 10, wherein the non-flat bottom floor is sloped.

Aspect 12: The system according to aspect 11, wherein the non-flat bottom floor is sloped to form a conical shaped floor.

Aspect 13: The system according to any one of aspects 10-12, wherein all of the plurality of air distribution lines extend to different depths within the fluid of the vessel.

Aspect 14: The system according to any one of aspects 10-13, wherein at least two of the plurality of air distribution lines extend into the fluid formed in the non-flat bottom floor of the vessel at different depths.

Aspect 15: The system according to any one of aspects 10-14, wherein the air diffuser units are positioned at different elevations within the fluid of the vessel and at least one of the air diffuser units is positioned within the fluid formed in the non-flat bottom floor of the vessel.

Aspect 16: The system according to any one of aspects 10-15, wherein sizes of the orifice plates, mass flow of air for distribution to the grids, and operating pressure of air to the grids are calculated based on a mathematical model.

Aspect 17: The system according to any one of aspects 10-16, wherein the orifice plates are positioned above a surface of the fluid contained in the vessel.

Aspect 18: The system according to any one of aspects 10-17, further comprising distributing air from the blower or compressor to an air distribution header pipe that is connected to the air distribution lines.

### BRIEF DESCRIPTION OF THE DRAWINGS

FIG. 1 is a front cross-sectional view of a multiple submergence depth diffused air system according to a non-limiting embodiment of the present disclosure.

### DESCRIPTION OF THE INVENTION

For the purpose of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plurals encompasses the singular, unless specifically stated otherwise. In addition, in this application, the use of “or” means “and/or” unless specifically stated otherwise, even though “and/or” may be explicitly used in certain instances.

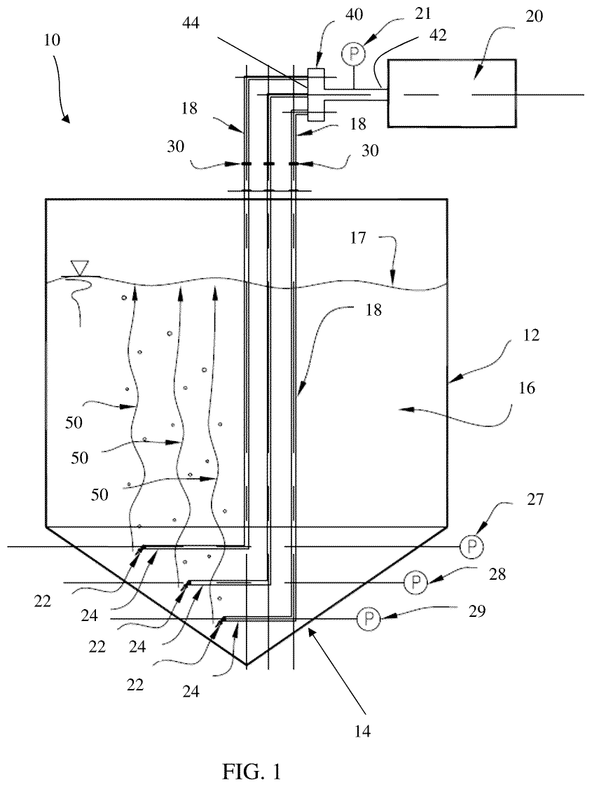

Referring to FIG. 1, a multiple submergence depth diffused air system 10 according to the present disclosure generally includes a vessel 12 comprising a non-flat bottom floor 14. For instance, at least a portion of the floor 14 of the vessel 12 can be sloped. In certain non-limiting embodiments, the floor 14 of the vessel 12 is sloped to form a conical shaped floor 14. It is appreciated that the vessel 12 can be used in a variety of industries and purposes where diffused air is applied to fluid 16 in the vessel 12, such as biological process fluid, to provide mixing of the fluid 16, solids suspension, and/or dissolved oxygen transfer.

In certain non-limiting embodiments, the system 10 includes a plurality (e.g., two or more, or three or more) air distribution lines 18 that extend from a single blower/compressor 20, which provides a single mass flow/single pressure discharge of air, into the fluid 16 of the vessel 12. At least two of the air distribution lines 18 extend to different depths of the vessel 12 with at least one of the air distribution lines 18 extending into the non-flat bottom floor 14 area of the vessel 12. In certain non-limiting embodiments, all of the air distribution lines 18 extend to different depths of the vessel 12. Further, in some non-limiting embodiments, at least two, or all of the air distribution lines 18, extend into the non-flat bottom floor 14 area of the vessel 12, such as extending into different depths of the non-flat bottom floor 14 area of the vessel 12.

It is appreciated that the system 10 can comprise as many air distribution lines 18 as necessary to achieve the desired mixing of fluid 16, solids suspension, and/or dissolved oxygen transfer. For example, referring to FIG. 1, three different air distribution lines 18 extend from a single blower/compressor 20 into the fluid 16 of the vessel 12. As further shown in FIG. 1, in certain non-limiting embodiments, the three different air distribution lines 18 extend into the non-flat bottom floor 14 of the vessel 12 at different depths.

As shown in FIG. 1, the air distribution lines 18 include distribution grids 22 comprising air diffuser units 24. As previously described, at least some of the air distribution lines 18 extend into the vessel 12 at different depths. As a result, the air diffuser units 24 are positioned at different elevations. For instance, referring to FIG. 1 and in some non-limiting embodiments, the three different air distribution lines 18 extend into the non-flat bottom floor 14 of the vessel 12 at different depths and comprise air diffuser units 24 positioned at different elevations.

In certain non-limiting embodiments, the system 10 further includes individual orifice plates 30 associated with each air distribution line 18. Each orifice plate 30 is sized and configured to produce a unique pressure head for each air distribution line 18 at a designated mass flow of air to the respective air distribution line 18 and corresponding distribution grids 22. The total mass of air discharged from the blower/compressor 20 will be divided into the air distribution lines 18 at airflow rates proportional to the associated fluid volume designated to each air distribution line 18.

It is appreciated that the blower/compressor 20 will produce a single mass flow of air at a single operating pressure point. Each of the air distribution lines 18 will discharge the proportional airflow associated with the fluid volume designated for the specific air distribution line 18. The orifice plates 30 located in the air distribution lines 18 will control the mass air flow rate and operating pressure to each air distribution line 18. The fixed orifice plates 30 can therefore be utilized in the air distribution lines 18 to provide the required flow and pressure to each distribution grid 22 (pressures points for each grid 22 shown in FIG. 1 as reference numbers 27, 28, and 29). Mathematical models can be utilized to calculate the required mass flow to be distributed to each grid 22 and the required operating pressure for each grid 22, as well as the orifice plate 30 sizing.

The orifice plates 30 can be positioned in various points along the air distribution lines 18. For example, referring to FIG. 1, the orifice plates 30 can be positioned on the air distribution lines 18 above the vessel 12 or at least on the air distribution lines 18 above the surface 17 of the fluid 16. The orifice plates 30 can also be positioned next to each other along the various air distribution lines 18, or the orifice plates 30 can be located at different positions along the different air distribution lines 18.

In certain non-limiting embodiments, referring to FIG. 1, the blower/compressor 20 is connected and in fluid communication with the first end 42 of an air distribution header pipe 40. As further shown in FIG. 1, the air distribution lines 18 are connected to the second end 44 of the air distribution header pipe 40. During operation, the blower/compressor 20 discharges air at a designated mass flow rate and operating pressure point (e.g., as represented as reference number 21 in FIG. 1) into the air distribution header pipe 40 and then through the plurality of air distribution lines 18 that each have a unique sized orifice plate 30, as previously described.

The present disclosure also relates to a method of diffusing air into a vessel 12 for mixing fluids, solids suspension, and/or dissolved oxygen transfer. The method includes distributing air from the single blower or compressor 20 into the plurality of air distribution lines 18. As previously described, at least some (e.g. at least two) of the air distribution lines 18 extend to different depths of the vessel 12 with at least one of the air distribution lines 18 extending into the non-flat bottom floor 14 area of the vessel 12. In certain non-limiting embodiments, all of the air distribution lines 18 extend to different depths of the vessel 12. Further, in some non-limiting embodiments, at least two, or all of the air distribution lines 18, extend into the non-flat bottom floor 14 area of the vessel 12, such as extending into different depths of the non-flat bottom floor 14 area of the vessel 12.

In certain non-limiting embodiments, the method further includes discharging air from the blower/compressor 20 at a designated mass flow rate and operating pressure point into the air distribution header pipe 40 and then into the plurality of air distribution lines 18, as previously described.

The method further includes producing a unique pressure head for each air distribution line 18 at a designated mass flow of air to the respective air distribution line 18 with individual orifice plates 30 associated with each air distribution line 18. The method then includes discharging through each air distribution line 18 the proportional airflow associated with the fluid volume designated for the specific air distribution line 18. As such, the orifice plates 30 located in the air distribution lines 18 will control the mass air flow rate and operating pressure to each air distribution line 18.

The air flows through the air distribution lines 18 at the designated mass flow of air and operating pressure to the grids 22 comprising air diffuser units 24, which are positioned at different elevations within the fluid 16 of the vessel 12 including some within the non-flat bottom floor 14 area. Air released from the air diffuser units 24 will provide mixing of the fluid 16, solids suspension, and/or dissolve oxygen transfer across the entire fluid 16 body. FIG. 1 further illustrates the air flow 50 through the fluid 16 after being released.

It was found that the previously described system 10 and corresponding method allow the standard blower/compressor 20 to operate at a single mass flow and single operating pressure, while providing proportional mass distribution of air across multiple fluid elevation depths. As a result, the system 10 and method described herein are able to eliminate issues with accumulated solids and un-mixed areas, while optimizing the mixing and oxygen transfer across the entire fluid 16 body in a conical and non-flat bottom 14 vessels.

Whereas particular embodiments of this invention have been described above for purposes of illustration, it will be evident to those skilled in the art that numerous variations of the details of the present invention may be made without departing from the invention.

The invention claimed is:

1. A multiple submergence depth diffused air system comprising:
a vessel comprising a non-flat bottom floor and fluid contained within the vessel;
a single blower or compressor that provides a single mass flow and a single pressure discharge of air;
a plurality of air distribution lines that extend from the single blower or compressor into the fluid contained within the vessel, in which outlets of the plurality of air distribution lines have grids comprising air diffuser units for distributing air into the fluid; and
orifice plates associated with each air distribution line,
wherein at least some of the air distribution lines extend to different depths within the fluid of the vessel and at least one of the air distribution lines extends into the fluid formed in the non-flat bottom floor of the vessel, and
wherein the orifice plates are sized and configured to produce a unique pressure head for each air distribution line at a designated mass flow of air to the respective air distribution line.

2. The system according to claim 1, wherein the non-flat bottom floor is sloped.

3. The system according to claim 2, wherein the non-flat bottom floor is sloped to form a conical shaped floor.

4. The system according to claim 1, wherein all of the plurality of air distribution lines extend to different depths within the fluid of the vessel.

5. The system according to claim 1, wherein at least two of the plurality of air distribution lines extend into the fluid formed in the non-flat bottom floor of the vessel at different depths.

6. The system according to claim 1, wherein the air diffuser units are positioned at different elevations within the fluid of the vessel and at least one of the air diffuser units is positioned within the fluid formed in the non-flat bottom floor of the vessel.

7. The system according to claim 1, wherein sizes of the orifice plates, mass flow of air for distribution to the grids, and operating pressure of air to the grids are calculated based on a mathematical model.

8. The system according to claim 1, wherein the orifice plates are positioned above a surface of the fluid contained in the vessel.

9. The system according to claim 1, further comprising an air distribution header pipe comprising a first end connected with the blow or compressor, and the air distribution lines are connected to a second end of the air distribution header pipe.

10. A method of diffusing air into a vessel for mixing fluids, solids suspension, and/or dissolved oxygen transfer, the method comprising:
distributing air from a single blower or compressor into a plurality of air distribution lines that extend into a vessel comprising a non-flat bottom floor and fluid contained within the vessel, the blower or compressor providing a single mass flow and a single pressure discharge of air;
producing a unique pressure head for each air distribution line at a designated mass flow of air to each respective air distribution line by individual orifice plates associated with each air distribution line;
distributing air through each air distribution line at a proportional airflow associated with a fluid volume designated for each air distribution line;
discharging air at the designated mass flow of air and an operating pressure to outlets of the plurality of air distribution lines comprising grids with air diffuser units; and
releasing air from the air diffuser units to mix the fluid, provide solids suspension, and/or dissolve oxygen,
wherein the at least some of the air distribution lines extend to different depths within the fluid of the vessel and at least one of the air distribution lines extends into the fluid formed in the non-flat bottom floor of the vessel.

11. The method of claim 10, wherein the non-flat bottom floor is sloped.

12. The method of claim 11, wherein the non-flat bottom floor is sloped to form a conical shaped floor.

13. The method of claim 10, wherein all of the plurality of air distribution lines extend to different depths within the fluid of the vessel.

14. The method of claim 10, wherein at least two of the plurality of air distribution lines extend into the fluid formed in the non-flat bottom floor of the vessel at different depths.

15. The method of claim 10, wherein the air diffuser units are positioned at different elevations within the fluid of the vessel and at least one of the air diffuser units is positioned within the fluid formed in the non-flat bottom floor of the vessel.

16. The method of claim 10, wherein sizes of the orifice plates, mass flow of air for distribution to the grids, and operating pressure of air to the grids are calculated based on a mathematical model.

17. The method of claim 10, wherein the orifice plates are positioned above a surface of the fluid contained in the vessel.

18. The method of claim 10, further comprising distributing air from the blower or compressor to an air distribution header pipe that is connected to the air distribution lines.
